(19) United States
(12) Patent Application Publication
(10) Pub. No.: US 2017/0110071 A1
(43) Pub. Date: Apr. 20, 2017

(54) IMAGE DISPLAY APPARATUS AND COLOR CONVERSION APPARATUS

(71) Applicant: CANON KABUSHIKI KAISHA, Tokyo (JP)

(72) Inventor: Muneki Ando, Kawasaki-shi (JP)

(21) Appl. No.: 15/284,818

(22) Filed: Oct. 4, 2016

(30) Foreign Application Priority Data
Oct. 15, 2015 (JP) 2015-203978
Aug. 4, 2016 (JP) 2016-153474

(51) Int. Cl. G09G 3/36; G06T 11/00

(52) U.S. Cl. CPC G09G 3/3607; G06T 11/001; G09G 2340/06; G09G 2320/0666

(57) ABSTRACT

An image display apparatus according to the present invention includes: a setting unit configured to perform setting related to display brightness of the image display apparatus; and a correcting unit configured to reduce saturation of an input color and increase lightness of an input color, wherein the correcting unit determines an amount of increasing the lightness of the input color based on the display brightness, which has been set by the setting unit.

### BACKGROUND OF THE INVENTION

Field of the Invention

The present invention relates to an image display apparatus and a color conversion apparatus.

Description of the Related Art

As a method for converting a color outside a predetermined color gamut into a color within the predetermined color gamut, a method of reducing (compressing) saturation while maintaining hue and lightness is known (Japanese Patent Application Laid-Open No. 2014-33273). In the case of the method disclosed in Japanese Patent Application Laid-Open No. 2014-33273, lightness is increased according to the degree of reducing saturation.

A visual effect called the “Helmholtz-Kohlrausch effect (HK effect)” is known. The HK effect is a visual effect that causes perceiving a color with high saturation as a bright color, and a color with low saturation as a dark color.

If a color is converted using the method of reducing saturation with maintaining hue and lightness, the perceptual lightness (apparent lightness) may drop due to the HK effect. As mentioned above, in the case of the method disclosed in Japanese Patent Application Laid-Open No. 2014-33273, the lightness is increased according to the degree of reducing saturation. However, the degree of the HK effect (difference between a physically defined lightness and the perceptual lightness) does not depend on saturation alone. Therefore, in the case of the method of increasing lightness according to the degree of reducing saturation, the perceptual lightness cannot be maintained at high precision. Further, in the case of this conventional method, the difference between the perceptual lightness of the color before conversion and the perceptual lightness of the color after conversion depends on the color before conversion. Therefore if the color of each pixel of the image data is converted, the balance of the perceptual lightness among these pixels may be altered.

### SUMMARY OF THE INVENTION

The present invention provides a technique to control the change of lightness to be perceived in a case where an input color is converted.

The present invention in its first aspect provides an image display apparatus comprising:

a setting unit configured to perform setting related to display brightness of the image display apparatus; and

a correcting unit configured to reduce saturation of an input color and increase lightness of an input color, wherein

the correcting unit determines an amount of increasing the lightness of the input color based on the display brightness, which has been set by the setting unit.

The present invention in its second aspect provides a color conversion apparatus comprising:

an acquiring unit configured to acquire information related to display brightness set in an image display apparatus; and

a correcting unit configured to reduce saturation of an input color and increase lightness of an input color, wherein

the correcting unit determines an amount of increasing the lightness of the input color, based on the display brightness, which has been set in the image display apparatus.

The present invention in its third aspect provides a color conversion method comprising:

acquiring information related to display brightness set in an image display apparatus;

reducing saturation of an input color; and

increasing lightness of an input color, wherein

an amount of increasing the lightness of the input color is determined based on the display brightness, which has been set in the image display apparatus.

The present invention in its fourth aspect provides a non-transitory computer readable medium that stores a program, wherein

the program causes a computer to execute:
acquiring information related to display brightness set in an image display apparatus;
reducing saturation of an input color; and
increasing lightness of an input color, and

an amount of increasing the lightness of the input color is determined based on the display brightness, which has been set in the image display apparatus.

According to the present invention, the change of lightness to be perceived can be controlled in a case where an input color is converted.

Further features of the present invention will become apparent from the following description of exemplary embodiments with reference to the attached drawings.

### BRIEF DESCRIPTION OF THE DRAWINGS

FIG. 1 is a block diagram depicting an example of a configuration of an image display apparatus according to Example 1;

FIG. 2 shows an example of an LUV conversion table according to Example 1;

FIG. 3 is a flow chart depicting an example of a processing flow of the image display apparatus according to Example 1;

FIG. 4 shows an example of an equivalent perceptual lightness conversion table according to Example 1;

FIGS. 5A to 5C are diagrams for describing a concrete example of an operation of the image display apparatus according to Example 1;

FIG. 6 is a block diagram depicting an example of a configuration of an image display apparatus according to Example 2;

FIG. 7 is a block diagram depicting an example of a configuration of an image display apparatus according to Example 3;

FIG. 8 is a diagram for describing a concrete example of the operation of the image display apparatus according to Example 3;

FIG. 9 is a block diagram depicting an example of a configuration of an image display apparatus according to Example 4;

FIG. 10 is a block diagram depicting an example of a configuration of an image display apparatus according to Example 5;

FIG. 11 is a block diagram depicting an example of a configuration of a computer according to Example 6;

FIG. 12 is a flow chart depicting an example of a processing flow of the software according to Example 6;

FIG. 13 is a flow chart depicting an example of a processing flow of an image display apparatus according to Example 7; and

FIGS. 14A and 14B are diagrams depicting a concrete example of an operation of the image display apparatus according to Example 7.

### DESCRIPTION OF THE EMBODIMENTS

### EXAMPLE 1

Example 1 of the present invention will now be described. A color conversion apparatus according to this example determines an output color, which is a color after conversion, with respect to an input color, which is a color before conversion. In the following, an example in a case where an image processing apparatus includes the color conversion apparatus according to Example 1, and an image display apparatus includes this image processing apparatus, will be described. The color conversion apparatus may be an apparatus that is separate from the image processing apparatus. Further, the image processing apparatus may be an apparatus that is separate from the image display apparatus.

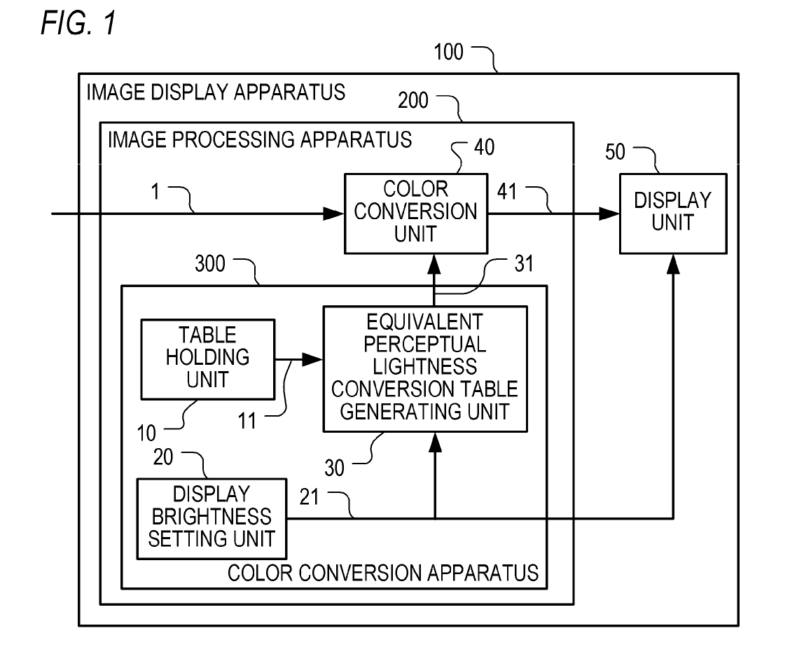

FIG. 1 is a block diagram depicting an example of a configuration of an image display apparatus 100 according to Example 1. The image display apparatus 100 includes an image processing apparatus 200 and a display unit 50. The image processing apparatus 200 has a color conversion apparatus 300 and a color conversion unit 40. The color conversion apparatus 300 has a table holding unit 10, a display brightness setting unit 20, and an equivalent perceptual lightness conversion table generating unit 30.

Input image data 1 is image data that is input to the image display apparatus 100 via an input terminal (not illustrated). In this example, the input image data 1 is image data having RGB values as pixel values. Each of the R value, G value and B value is an 8-bit value (0 to 255). The pixel values of the image data are not limited to RGB values. For example, the pixel values of the image data may be YCbCr values. A number of bits of the gradation value may be more or less than 8 bits. The input image data 1 may be input to the image display apparatus 100 via cable, or may be input to the image display apparatus 100 via wireless communication.

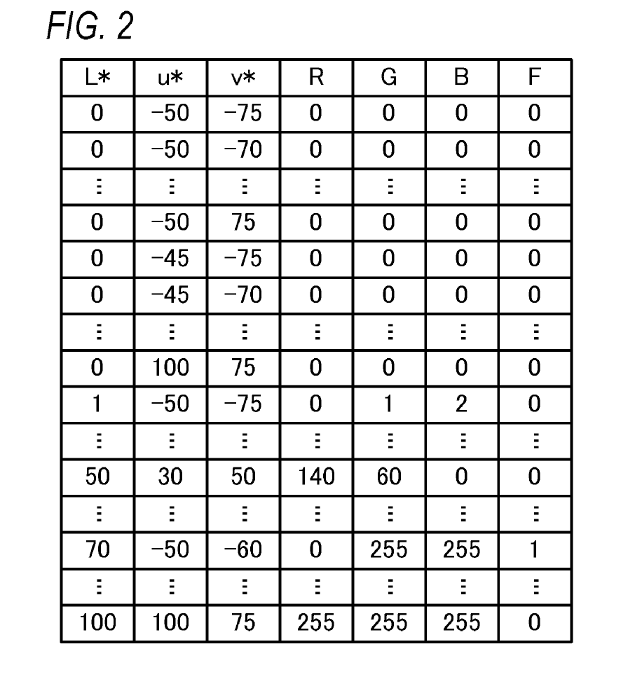

The table holding unit 10 is a storage unit that holds an LUV conversion table 11. For the table holding unit 10, a semiconductor memory, a magnetic disk, an optical disk or the like can be used, for example. In this example, a ROM is used for the table holding unit 10. FIG. 2 shows an example of the LUV conversion table 11. The LUV conversion table 11 is a three-dimensional look-up table (3DLUT) which indicates the correspondence between the L*u*v* values (values in the L*u*v* color space) and the RGB values. By using the LUV conversion table 11, the L*u*v* values can be converted into the RGB values, or the RGB values can be converted into the L*u*v* values.

In the LUV conversion table 11, RGB values representing a color that can be displayed on the display unit 50 (displayable color) are corresponded with the L*u*v* values representing a pseudo-color outside a visible range. “Visible range” is a range of colors that humans can perceive. In the LUV conversion table 11, RGB values representing a displayable color are corresponded with the L*u*v* values representing a color that cannot be displayed on the display unit 50. An inappropriate color flag F=0 is assigned to the L*u*v* values showing displayable colors inside the visible range. An inappropriate color flag F=1 is assigned to the L*u*v* values representing a pseudo-color outside the visible range and the L*u*v* values representing a color that cannot be displayed on the display unit 50. This means that it can be determined whether or not the color represented by the L*u*v* values is an inappropriate color by referring to the inappropriate color flag F=1. In Example 1, the inappropriate colors are the pseudo-colors outside the visible range and the colors that cannot be displayed on the display unit 50.

The configuration of the LUV conversion table 11 is not limited to the above configuration. For example, only the L*u*v* values of appropriate colors (colors other than inappropriate colors) may be indicated in the LUV conversion table 11. In this case, the L*u*v* values that are not indicated in the LUV conversion table 11 can be detected as the L*u*v* values of inappropriate colors. The inappropriate colors may be only one of the pseudo-colors outside the visible range and colors that cannot be displayed on the display unit 50. For example, only the colors that cannot be displayed on the display unit 50 may be used as the inappropriate colors. Instead of the LUV conversion table 11, functions indicating the correspondence of the L*u*v* values and the RGB values may be used.

The display brightness setting unit 20 sets reference display brightness 21 using a user interface (not illustrated) according to the user operation performed for the image display apparatus 100. Brightness may be replaced by luminance. The reference display brightness is a reference value of the display brightness (brightness of the screen). The reference display brightness 21 can be regarded as the “upper limit value of the display brightness” or as the “parameter to determine the brightness of the image to be displayed on the display unit 50”. In Example 1, the reference display brightness 21 is assumed to be the brightness of a pixel which is displayed in a case where pixel values of the input image data 1 are pixel values of a 100% white pixel. If 8-bit RGB values (R value, G value, B value) are used as the pixel values of the input image data 1, the pixel values of a 100% white pixel are RGB values (255, 255, 255), for example.

The unit of the reference display brightness 21 is not especially limited. In Example 1, [cd/m²] is used as the unit of the reference display brightness 21. For example, if the value of the reference display brightness 21 is 100, a 100% white pixel is displayed as 100 [cd/m²] on the display unit 50. The reference display brightness 21 may be a predetermined fixed value, or may be automatically determined according to the type of the input image data 1, the operation mode of the image display apparatus 100, an operation environment of the image display apparatus 100 and the like.

The equivalent perceptual lightness conversion table generating unit 30 generates an equivalent perceptual lightness conversion table 31 based on the LUV conversion table 11 and the Helmholtz-Kohlrausch effect (HK effect). The equivalent perceptual lightness conversion table 31 is generated every time the reference display brightness is changed. That is, the equivalent perceptual lightness conversion table 31 is updated every time the reference display brightness 21 is changed. The equivalent perceptual lightness conversion table 31 is color conversion information to convert an input color, which is a color be fore the conversion, into an output color, which is a color after the conversion. The output color is a color acquired by converting the input color considering the HK effect. The configuration of the equivalent perceptual lightness conversion table 31 and the method for generating the equivalent perceptual lightness conversion table 31 will be described in detail later.

The color conversion unit 40 generates the display image data 41 by converting the color of each pixel of the input image data 1 based on the equivalent perceptual lightness conversion table 31 (color conversion processing). In concrete terms, the color conversion unit 40 generates the display image data 41 by converting each pixel value of the input image data 1 based on the equivalent perceptual lightness conversion table 31. In a case where the display image data 41 is generated, image processing other than the color conversion processing may also be performed.

The display unit 50 displays an image based on the display image data 41. In this example, an image is displayed on the screen based on the display image data 41 and the reference display brightness 21. The display unit 50 has a light emitting unit and a modulation panel configured to display an image on the screen by modulating light from the light emitting unit. In this example, the display unit 50 is a transmission type display unit that includes a backlight module and a liquid crystal panel. The backlight module irradiates light onto the rear surface of the liquid crystal panel. The liquid crystal panel forms a transmittance pattern according to the image data input to the display unit 50. An image is displayed on the screen in a case where the light from the backlight module transmits through the liquid crystal panel at the transmittance according to the image data input to the display unit 50. The backlight module emits light at an emission brightness (emission intensity) according to the reference display brightness 21. Thereby, the brightness in the screen region, where the pixel value of the display image data is the pixel value of a 100% white pixel (display brightness), approximately matches with the brightness specified by the reference display brightness 21. The meaning of “appropriately matches” includes “completely matches”.

The configuration of the display unit 50 is not especially limited. For example, a reflection type display unit, which displays an image on the screen by reflecting the light irradiated onto the front surface, may be used as the display unit 50. The reflection type display unit forms a reflectance pattern according to the image data input to the display unit 50, for example. Instead of the liquid crystal elements of the liquid crystal panel, a microelectromechanical systems (MEMS) shutter type display unit, which uses MEMS shutters, may be used as the display unit 50. An organic EL display panel, a plasma display panel or the like may be used as the display unit 50.

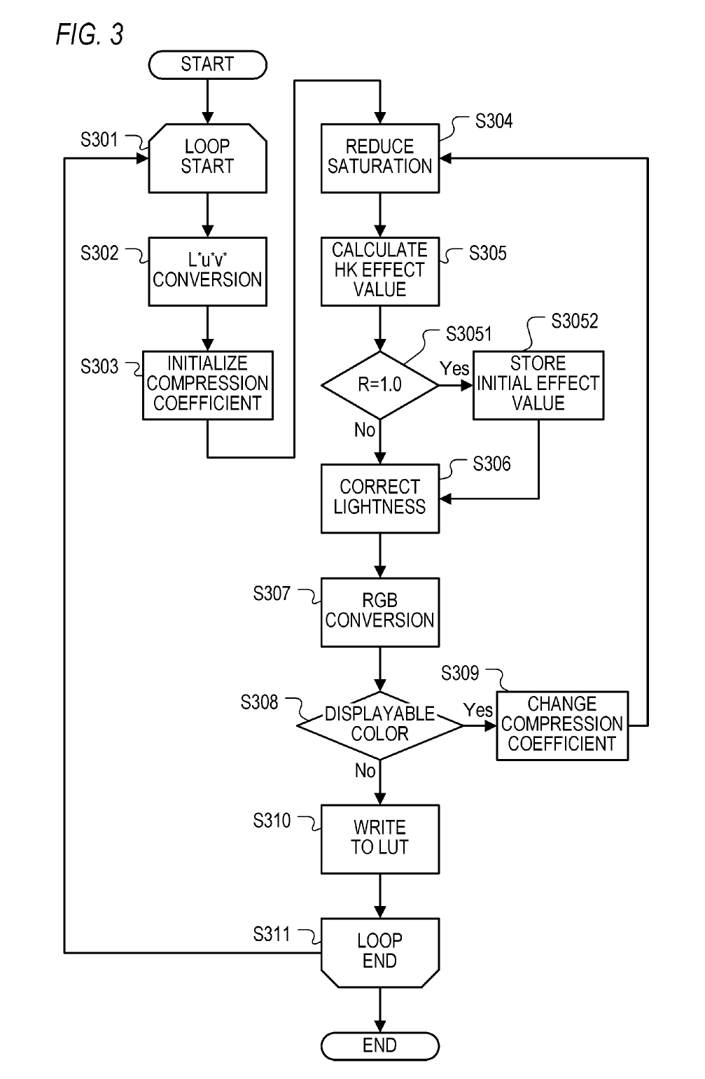

Now an example of a method for generating the equivalent perceptual lightness conversion table 31 and an example of a configuration of the equivalent perceptual lightness conversion table 31 will be described in detail. FIG. 3 is a flow chart depicting an example of a method for generating the equivalent perceptual lightness conversion table 31. A part of the processing shown in the flow chart of FIG. 3 may be performed by a functional unit that is different from the equivalent perceptual lightness conversion table generating unit 30.

First in S301, the equivalent perceptual lightness conversion table generating unit 30 starts loop processing. The loop processing in S301 is a repeat of the processing to select a color within a predetermined color gamut as the input color. By the loop processing in S301, each color in the predetermined color gamut is sequentially selected as an input color. The predetermined color gamut is not especially limited. In this example, the predetermined color gamut is a range of colors corresponding to a range of possible pixel values of the input image data 1. In Example 1, each possible pixel value of the input image data 1 is sequentially selected as the pixel values (R value, G value, B value)=(iR, iG, iB) of the input color. In concrete terms, in S301, triple loop processing operations, that is: a loop processing to gradually change the R value from 0 to 255; a loop processing to gradually change a G value from 0 to 255; and a loop processing to gradually change the B value from 0 to 255, are performed. By triple loop processing operations, each possible pixel value of the input image data 1 is sequentially selected as the pixel values (iR, iG, iB) of the input color.

Then in S302, the equivalent perceptual lightness conversion table generating unit 30 converts the pixel value (iR, iG, iB) selected in S301 into the L*u*v* values (L* value, u* value, v* value)=(L0, U0, V0).

The processing in S302 will be described in detail.

First the XYZ values (X value, Y value, Z value) of a red point=(RX, RY, RZ), the XYZ values of a green point=(GX, GY, GZ), the XYZ values of a blue point=(BX, BY, BZ), and the XYZ values of a white point=(WX, WY, WZ) are acquired by a profile acquiring unit (not illustrated). The red point can be called the “R origin”, the green point can be called the “G origin”, and the blue point can be called the “B origin”. These XYZ values may be provided in advance.

Then the equivalent perceptual lightness conversion table generating unit 30 calculates the XYZ values of the input color=(iX, iY, iZ) according to the following Expression 1 defined by commission internationale de l'éclairage (CIE) standards.

$$\begin{matrix}[ Math . 1 ] & \\ ( \begin{matrix}iX \\ iY \\ iZ\end{matrix} ) = ( \begin{matrix}RX & GX & BX \\ RY & GY & BY \\ RZ & GZ & BZ\end{matrix} ) ( \begin{matrix}iR \\ iG \\ iB\end{matrix} ) & ( Expression 1 )\end{matrix}$$

Then the equivalent perceptual lightness conversion table generating unit 30 calculates the u′v′ color coordinate values of the input color=(iu′, iv′) according to the following Expressions 2-1 and 2-2 defined by CIE standards.

iu′=4×iX/(iX+15×iY+3×iZ) (Expression 2-1)

iv′=9×iY/(iX+15×iY+3×iZ) (Expression 2-2)

Then the equivalent perceptual lightness conversion table generating unit 30 calculates the u′v′ color coordinate values of the white point=(Wu′, Wv′) according to the following Expressions 3-1 and 3-2 defined by CIE standards.

Wu′=4×WX/(WX+15×WY+3×WZ) (Expression 3-1)

Wv′=9×WY/(WX+15×WY+3×WZ) (Expression 3-2)

Then the equivalent perceptual lightness conversion table generating unit 30 calculates the L*u*v* values of the input color (L0, U0, V0) according to the following Expressions 4-1 to 4-3 defined by CIE standards.

L0=116×(iY/WY)^{1/3}−16 (Expression 4-1)

U0=13×L0×(iu′−Wu′) (Expression 4-2)

V0=13×L0×(iv′−Wv′) (Expression 4-3)

Refer back to the description of FIG. 3. After the processing of S302, the equivalent perceptual lightness conversion table generating unit 30 initializes a reduction coefficient R to 1.0 in S303. The reduction coefficient R is a coefficient (ratio) to reduce the saturation. Saturation may be replaced by chroma, color saturation, or color intensity. The reduction coefficient R=1.0 is a reduction rate that does not reduce the saturation. The reduction coefficient R is a 1.0 or less value, whereby as the reduction coefficient R is smaller, the reduction rate to reduce saturation is higher.

Then in S304, the equivalent perceptual lightness conversion table generating unit 30 acquires a corrected saturation by reducing the saturation of the input color (first correcting processing). The corrected saturation is saturation of the input color after the reduction of the saturation. In concrete terms, the equivalent perceptual lightness conversion table generating unit 30 calculates the L*u*v* values (L0, U, V) of a color generated by reducing the saturation of the input color (first corrected color) according to the following Expressions 5-1 and 5-2 defined by CIE standards. If the reduction coefficient R=1.0, the first corrected color matches with the input color.

U=U0×R (Expression 5-1)

V=V0×R (Expression 5-2)

Then in S305 to S306, the lightness of the input color is increased based on the hue of the input color, the saturation of the input color before the reduction, the corrected saturation and the reference display brightness 21, so that a drop in the perceptual lightness, due to the reduction of the saturation of the input color, can be reduced (second correcting processing). Lightness may be replaced by luminosity. Thereby a corrected lightness can be acquired. The corrected lightness is the lightness of the input color after the increase of the lightness. Here a case where the reference display brightness 21 is a fixed value will be considered. In this case, the second correcting processing can be regarded as a “processing to acquire the corrected lightness by increasing the lightness of the input color based on the hue of the input color, the saturation of the input color before the reduction, and the corrected saturation, so that a drop in the perceptual lightness, due to the reduction of the saturation of the input color, can be reduced (suppressed)”.

In S305, the equivalent perceptual lightness conversion table generating unit 30 calculates an HK effect value G of the first corrected color based on the reference display brightness 21 and the L*u*v* values (L0, U, V) of the first corrected color. The HK effect value G indicates the degree of the drop in the perceptual lightness due to the HK effect.

The processing in S305 will be described in detail.

First the equivalent perceptual lightness conversion table generating unit 30 calculates a hue angle θ using the following Expression 6. The hue angle θ is a hue angle of the first corrected color, and is also a hue angle of the input color.

θ=tan⁻¹(V/U) (Expression 6)

Then the equivalent perceptual lightness conversion table generating unit 30 calculates an HK effect factor Q corresponding to the hue angle θ using the following Expression 7.

Q=−0.01585−0.03017 cosθ−0.04556 cos 2θ−0.02667 cos 3θ−0.00295 cos 4θ+0.14592 sin θ+0.05082 sin 2θ−0.01900 sin 3θ−0.00764 sin 4θ (Expression 7)

Then the equivalent perceptual lightness conversion table generating unit 30 calculates an HK effect factor K corresponding to the reference display brightness 21 using the following Expression 8. In this example, a brightness constant La in Expression 8 is the reference display brightness 21. Normally an adaptation brightness of the observer should be used as the brightness constant La that is used for calculating the HK effect factor K. However, in the case of the image display apparatus, the adaptation brightness of the observer cannot be measured accurately. Therefore in Example 1, the reference display brightness 21 is used instead of the adaptation brightness. 100% white is displayed on the screen of the image display apparatus as the reference display brightness 21. If it is assumed that the observer is looking only at the screen, then the brightness of the 100% white, displayed on this screen, can be regarded as the adaptation brightness of the observer.

K=0.2717×((6.649+6.362×La^{0.4995})/(6.649+La^{0.4995})) (Expression 8)

Then the equivalent perceptual lightness conversion table generating unit 30 calculates an HK effect factor S corresponding to the saturation of the first corrected color using the following Expression 9.

S=(U²+V²)^{1/2}/L0 (Expression 9)

Then the equivalent perceptual lightness conversion table generating unit 30 calculates an HK effect value G of the first corrected color using the following Expression 10.

G=0.4462×(1+(−0.8660×Q+0.0872×K)×S+0.3086)³ (Expression 10)

In S3051, the equivalent perceptual lightness conversion table generating unit 30 determines whether or not the reduction coefficient R is 1.0. If the reduction coefficient is R=1.0, the HK effect value G of the input color is acquired in S305. If the reduction coefficient is R=1.0, the processing advances to S3052, and if the reduction coefficient is R≠1.0, the processing advances to S306.

In S3052, the equivalent perceptual lightness conversion table generating unit 30 stores the HK effect value G, which was acquired by the processing in S305, as an initial effect value G0. Then the processing advances to S306.

In S306, the equivalent perceptual lightness conversion table generating unit 30 calculates a corrected lightness L using the HK effect value. Then the equivalent perceptual lightness conversion table generating unit 30 determines a color (second corrected color) having the hue of the input color, the corrected saturation and the corrected lightness, as the output color converted from the input color. In concrete terms, the equivalent perceptual lightness conversion table generating unit 30 determines the L*u*v* values (L, U, V) as the L*u*v* values of the output color.

The processing of S306 will be described in detail.

First the equivalent perceptual lightness conversion table generating unit 30 calculates an HK effect ratio GR using the following Expression 11. The HK effect ratio GR is a ratio of the perceptual lightness of the first corrected color with respect to the perceptual lightness of the input color.

GR=G/G0 (Expression 11)

Then the equivalent perceptual lightness conversion table generating unit 30 calculates the corrected lightness L using the following Expression 12.

L=L0/GR (Expression 12)

According to the above method, a greater value is acquired for the difference between the lightness L0 of the input color before the increase and the corrected lightness L (amount of increasing lightness of the input color), as the difference between the saturation of the input color before the reduction and the corrected saturation becomes greater. Further, a greater value is acquired for the difference between the lightness L0 and the corrected lightness L, as the value of the reference display brightness 21 becomes greater.

In Example 1, the corrected saturation and the corrected lightness are updated so that a color in a narrower color gamut than the color gamut of the input colors (above mentioned predetermined color gamut) is determined as the output color. In Example 1, the corrected saturation and the corrected lightness are further updated so that a color that can be displayed on the display unit 50 (displayable color) is determined as the output color. In concrete terms, by the processing operations in S304 to S309, the increase of the lightness of the input color is repeated while gradually reducing the saturation of the input color until a displayable color is determined as the output color.

The methods for acquiring the corrected saturation and the corrected lightness are not limited to the above mentioned methods. For example, the reduction of saturation may be performed a predetermined number of times. The reduction of saturation may be performed only once, or may be performed a plurality of times.

Refer back to the description in FIG. 3. After S306, the equivalent perceptual lightness conversion table generating unit 30 converts the L*u*v* values (L, U, V) acquired in S306 into the RGB values (oR, oG, oB) with reference to the LUV conversion table 11 in S307. In concrete terms, an RGB values corresponding to the same L*u*v* values as the L*u*v* values (L, U, V) are acquired from the LUV conversion table 11 as the RGB values (oR, oG, oB). At this time, the equivalent perceptual lightness conversion table generating unit 30 acquires, from the LUV conversion table 11, an inappropriate color flag F corresponded to the same L*u*v* value as the L*u*v* values (L, U, V) from the LUV conversion table 11. Here the inappropriate color flag F=0 indicates that the color of the L*u*v* values corresponded to the inappropriate color flag F is a displayable color, and the inappropriate color flag F=1 indicates that the color of the L*u*v* values corresponded to the inappropriate color flag F is an undisplayable color. An undisplayable color is a color that cannot be displayed on the display unit 50.

Then in S308, the equivalent perceptual lightness conversion table generating unit 30 determines whether or not the color of the L*u*v* values (L, U, V) is a displayable color. In concrete terms, it is determined whether the value of the inappropriate color flag F acquired in S307 is 0 or 1. In the case of the inappropriate color flag F=0, it is determined that the color of the L*u*v* values (L, U, V) is a displayable color, and the processing advances to S310. In the case of the inappropriate color flag F=1, it is determined that the color of the L*u*v* values (L, U, V) is not a displayable color, and the processing advances to S309.

In S309, the equivalent perceptual lightness conversion table generating unit 30 reduces the reduction coefficient R using the following Expression 13. In other words, the reduction rate to reduce the saturation is increased. In Expression 13, R1 denotes a reduction coefficient before the reduction, R2 denotes a reduction coefficient after the reduction, and dR denotes an offset value to reduce the reduction coefficient R. In Example 1, 0.01 is used for the offset value dR.

R2=R1−dR (Expression 13)

Any value greater than 0 and smaller than 1 can be used for the offset value dR. The saturation can be reduced at higher precision as the offset value dR is smaller. Therefore the output color can be determined at higher precision as the offset value dR is smaller. However a drop in the offset value dR increases the processing load (number of times of repeats of the processing in S304 to S309). On the other hand, the output color can be determined with a smaller processing load as the offset value dR is greater. However an increase of the offset value dR causes overcorrection, which unnecessarily reduces the saturation. In other words, an increase of the offset value dR causes a drop in the precision of the processing to reduce the saturation and a drop in the precision of the processing to determine the output color. Therefore it is preferable to determine the offset value dR considering the processing precision and the processing load. The offset value dR may be a predetermined fixed value or a value that the user can change. The offset value dR may be automatically determined according to the type of the input image data, the operation mode of the image display apparatus 100, the operation environment of the image display apparatus 100 and the like.

In S310, the equivalent perceptual lightness conversion table generating unit 30 links the RGB values (iR, iG, iB) of the input color selected in S301 and the RGB values (oR, oG, oB) of the output color acquired in S307, and writes this data to the equivalent perceptual lightness conversion table 31.

In S311, the equivalent perceptual lightness conversion table generating unit 30 determines whether or not the processing operations in S301 to S310 were performed for all the input colors. If there is an input color which was not selected in S301, the processing returns to S301. Then the processing operations in S301 to S311 are repeated until the processing operations in S301 to S310 are performed for all the input colors. In a case where the processing operations in S301 to S310 are performed for all the input colors, the processing operations of this flow chart ends.

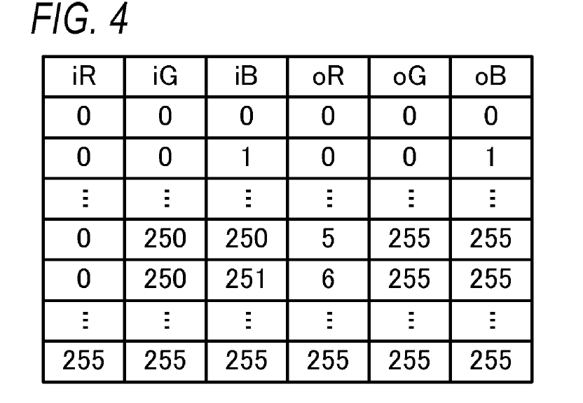

FIG. 4 shows an example of the equivalent perceptual lightness conversion table 31 generated according to the flow chart in FIG. 3. In the example of FIG. 4, the equivalent perceptual lightness conversion table 31 is a 3DLUT, which indicates the correspondence between the RGB values (iR, iG, iB) of the input color and the RGB value (oR, oG, oB) of the output color. The correspondence of the RGB values (iR, iG, iB) and the RGB values (oR, oG, oB) is one-to-one. Therefore the RGB values (iR, iG, iB) can be converted into the RGB values (oR, oG, oB) by using the equivalent perceptual lightness conversion table 31.

The configuration of the equivalent perceptual lightness conversion table 31 is not limited to the above mentioned configuration. For example, a table that indicates the correspondence between the L*u*v* values of the input color and the L*u*v* values of the output color may be used as the equivalent perceptual lightness conversion table 31. A table that indicates the correspondence between the RGB values of the input color and the L*u*v* values of the output color may be used as the equivalent perceptual lightness conversion table 31. A table that indicates the correspondence between the L*u*v* value of the input color and the RGB value of the output color may be used as the equivalent perceptual lightness conversion table 31. The color conversion information is not limited to the equivalent perceptual lightness conversion table 31. For example, a function that indicates the correspondence between the input color and the output color may be used as the color conversion information.

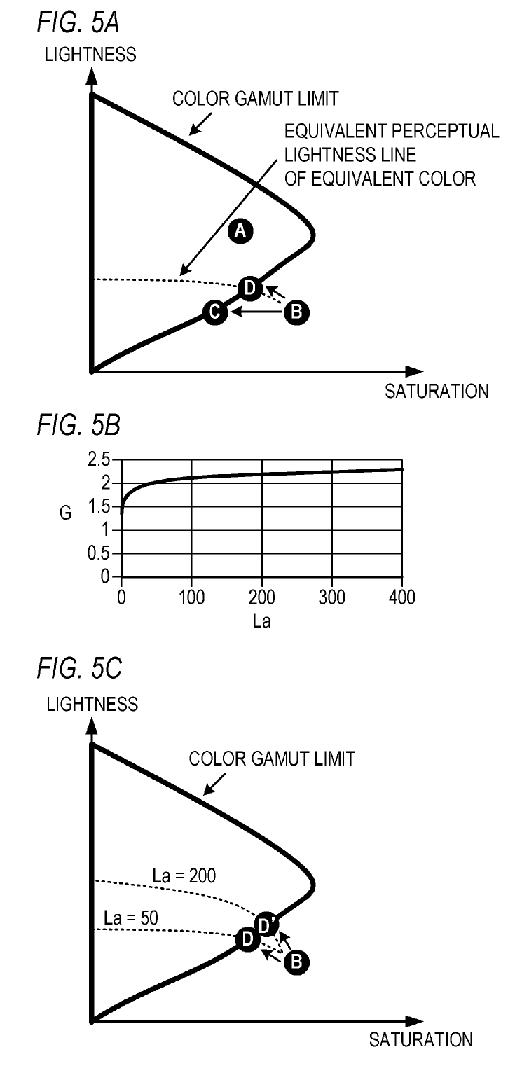

Now a concrete example of the operation of the image display apparatus 100 will be described. FIGS. 5A to 5C are diagrams for describing the concrete example of the operation of the image display apparatus 100. FIG. 5A shows a hue plane in the L*u*v* color space. The ordinate in FIG. 5A indicates the lightness, and the abscissa in FIG. 5A indicates the saturation. The region enclosed by the bold line is a color gamut (color gamut limit) of displayable colors. A pixel value can be plotted on any hue plane out of a plurality of hue planes.

First a case of plotting an input pixel value (a pixel value of the input image data 1) on point A in FIG. 5A will be considered. The color on point A is a displayable color. Therefore the image display apparatus 100 uses, without changing the color of the input pixel value, a same pixel value as the input pixel for the display pixel value (a pixel value of the display image data 41). As a result, a color the same as the color of the input pixel value is displayed.

Next a case of plotting an input pixel value on point B in FIG. 5A will be considered. The color at point B is not a displayable color. Therefore the input pixel value is converted into a display pixel value of a displayable color. In a conventional method, the saturation is reduced while maintaining the lightness. The display pixel value acquired by such a conventional method is plotted on point C in FIG. 5A. The color on point C, however, is perceived as a darker color than the color of point B because of the HK effect.

In Example 1, the saturation is reduced considering the HK effect. In concrete terms, the saturation is reduced along the equivalent perceptual lightness line (equivalent perceptual lightness color line of equivalent colors) in FIG. 5A. The equivalent perceptual lightness line indicates a plurality of colors having a same perceptual lightness. As a result, in Example 1, the pixel value plotted on point D in FIG. 5A is acquired as the display pixel value. The lightness of point D is higher than the lightness of point B. However, the color on point D is perceived with the same lightness as the color of point B because of the HK effect. Thus according to Example 1, a color can be converted while maintaining the perceptual lightness of each pixel. As a consequence, the image can be displayed without altering the balance of the perceptual lightness among the pixels.

As mentioned above, the degree of the HK effect changes depending on the lightness, the hue, the saturation and the reference display brightness. In concrete terms, the HK effect is smaller as the lightness is higher, the HK effect is small in a case where the hue is close to yellow, the HK effect is large in a case where the hue is reddish-purple to bluish-green, the HK effect is higher as the saturation is higher, and the HK effect is higher as the reference display brightness is higher. Further, as shown in FIG. 5B, the degree of the HK effect G is higher as the reference display brightness La is higher.

For this reason, as shown in FIG. 5C, the equivalent perceptual lightness line changes depending on the level of the reference display brightness, and the result of correcting the lightness changes depending on the reference display brightness La. In other words, even if the input pixel values have the same undisplayable color (point B), the lightness of the color after correction in a case where the reference display brightness is high (point D′) is higher than the lightness of the color after correction in a case where the reference display brightness is low (point D).

As described above, according to Example 1, not only is the saturation of the input color reduced, but also the lightness of the input color is increased. Thereby, the color can be converted while maintaining the perceptual lightness at high precision.

In this example, a case of correcting the lightness and saturation using the L*u*v* values was described, but values in a color space that is different from the L*u*v* color space may be used. For example, values in the L*a*b* color space may be used.

For the model of the HK effect, a model that is simpler than the model used in Example 1 may be used. For example, for the computation expression related to the HK effect, a computation expression that is simpler than the above mentioned expression may be used.

In the example of FIG. 5A, an undisplayable color is converted into a color on the boundary between display-impossible colors and the displayable colors, but the color after the conversion need not be a color on this boundary. For example, an undisplayable color may be converted into a displayable color so that the saturation of the output color smoothly drops from the saturation on the boundary as the saturation of the input color, which is an undisplayable color, drops.

Instead of selecting each color in a predetermined color gamut as an input color, a color of each pixel of the input image data may be selected as an input color, and an output color corresponding to the selected input color is determined using the abovementioned method. Then the color of each pixel of the input image data may be converted into the output color determined in this way. If the color conversion apparatus is an apparatus that is separate from the image processing apparatus, it is sufficient if the image processing apparatus includes a storage unit for storing the color conversion information. For the storage unit, a magnetic disk, a semiconductor memory, an optical disk or the like can be used.

In Example 1, a case of performing the reduction of the saturation of the input color and the increase of the lightness of the input color, in this sequence, was described, but the present invention is not limited to this sequence. For example, the lightness of the input color may be increased before reducing the saturation of the input color. The reduction of the saturation of the input color and the increase of the lightness of the input color may be performed at the same time. In concrete terms, information (table or function) indicating the equivalent perceptual lightness line in FIG. 5A is provided in advance, and the corrected saturation and the corrected lightness are simultaneously determined based on this information. It is sufficient if only the reduction of the saturation of the input color and the increase of the lightness of the input color are performed, so as to maintain the perceptual lightness of the input color.

### EXAMPLE 2

Example 2 of the present invention will now be described. In Example 1, a case of generating the equivalent perceptual lightness conversion table 31, every time the reference display brightness 21 is changed, was described. In Example 2, a case of providing the equivalent perceptual lightness conversion table in advance will be described. In the following, configurations and processing operations which are different from Example 1 will be described in detail, and description on the configurations and processing operations the same as Example 1 will be omitted.

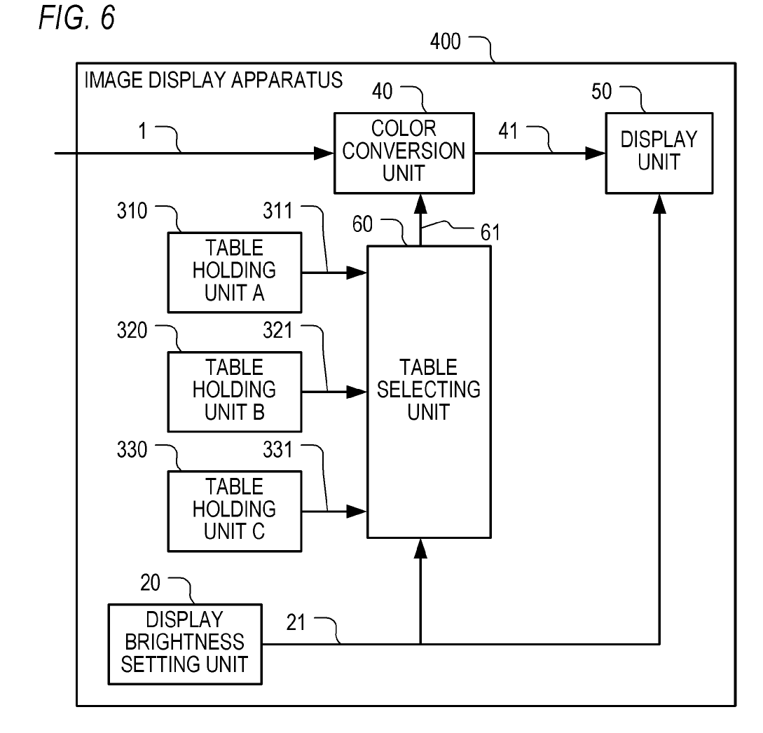

FIG. 6 is a block diagram depicting an example of a configuration of an image display apparatus 400 according to Example 2. In FIG. 6, a functional unit the same as Example 1 (FIG. 1) is denoted with a sign the same as Example 1. The image display apparatus 400 has a table holding unit A310, a table holding unit B320, a table holding unit C330, a table selecting unit 60, a display brightness setting unit 20, a color conversion unit 40 and a display unit 50.

The table holding unit A310, the table holding unit B320 and the table holding unit C330 store a plurality of equivalent perceptual lightness conversion tables corresponding to multiple reference display brightness respectively. The equivalent perceptual lightness conversion table is generated in advance by the same method as Example 1. For each of the table holding unit A310, the table holding unit B320 and the table holding unit C330, a semiconductor memory, a magnetic disk, an optical disk or the like can be used. In Example 2, a ROM is used for the table holding unit A310, the table holding unit B320 and the table holding unit C330 respectively.

In the table holding unit A310, an equivalent perceptual lightness conversion table 311, corresponding to the reference display brightness 21=100, is recorded in advance. In the table holding unit B320, an equivalent perceptual lightness conversion table 321, corresponding to the reference display brightness 21=200, is recorded in advance. And in the table holding unit C330, an equivalent perceptual lightness conversion table 331, corresponding to the reference display brightness 21=300, is recorded in advance.

The table selecting unit 60 selects one of the equivalent perceptual lightness conversion table 311, the equivalent perceptual lightness conversion table 321, and the equivalent perceptual lightness conversion table 331 according to the reference display brightness 21 output from the display brightness setting unit 20. In concrete terms, the equivalent perceptual lightness conversion table 311 is selected if the reference display brightness 21=100 is output from the display brightness setting unit 20. The equivalent perceptual lightness conversion table 321 is selected if the reference display brightness 21=200 is output from the display brightness setting unit 20. And the equivalent perceptual lightness conversion table 331 is selected if the reference display brightness 21=300 is output from the display brightness setting unit 20. Then the table selecting unit 60 outputs the selected equivalent perceptual lightness conversion table 61 to the color conversion unit 40. The color conversion unit 40 performs the color conversion processing using the equivalent perceptual lightness conversion table 61.

If the reference display brightness 21 output from the display brightness setting unit 20 is none of 100, 200 and 300, then the table selecting unit 60 performs the interpolation processing using the equivalent perceptual lightness conversion tables 311, 321 and 331. Thereby, an equivalent perceptual lightness conversion table, corresponding to the reference display brightness 21 output from the display brightness setting unit 20, is generated as the equivalent perceptual lightness conversion table 61.

As described above, according to Example 2, the equivalent perceptual lightness conversion table is provided in advance. Then the color conversion processing is performed using this equivalent perceptual lightness conversion table provided in advance. Thereby, colors can be converted while maintaining the perceptual lightness at high precision, and the processing loads of the image display apparatus and the image processing apparatus can be reduced.

The interpolation processing need not be performed. For example, even when an equivalent perceptual lightness conversion table, corresponding to the reference display brightness output from the display brightness setting unit, is not provided in advance, one of a plurality of equivalent perceptual lightness conversion tables provided in advance may be selected. In concrete terms, one equivalent perceptual lightness conversion table, corresponding to a reference display brightness closest to the reference display brightness output from the display brightness setting unit, may be selected from the plurality of equivalent perceptual lightness conversion tables provided in advance. And the color conversion processing may be performed using the selected equivalent perceptual lightness conversion table. According to this configuration, the color conversion processing can be performed with an approximate consideration of the HK effect. Therefore colors can be converted while maintaining the perceptual lightness at high precision. Moreover, the processing loads of the image display apparatus and the image processing apparatus can be further reduced.

A number of equivalent perceptual lightness conversion tables provided in advance may be 1. And the color conversion processing, using this equivalent perceptual lightness conversion table provided in advance, may always be performed regardless of the reference display brightness 21 output from the display brightness setting unit 20. According to this configuration, not only can the color be converted while maintaining the perceptual lightness at high precision, but also the processing load of the image display apparatus and the image processing apparatus can be further reduced. Moreover, by decreasing the number of the equivalent perceptual lightness conversion tables that are generated in advance, the processing load, in a case where the color conversion apparatus generates the equivalent perceptual lightness conversion tables in advance, can be reduced.

### EXAMPLE 3

Example 3 of the present invention will now be described. In Example 1, a case of generating the equivalent perceptual lightness conversion table 31 for correcting both the color gamut and the lightness was described. In Example 3, a case of independently performing the correction of the color gamut and the correction of the lightness will be described. In the following description, configurations and processing operations which are different from Example 1 will be described in detail, and description on the configurations and processing operations the same as Example 1 will be omitted.

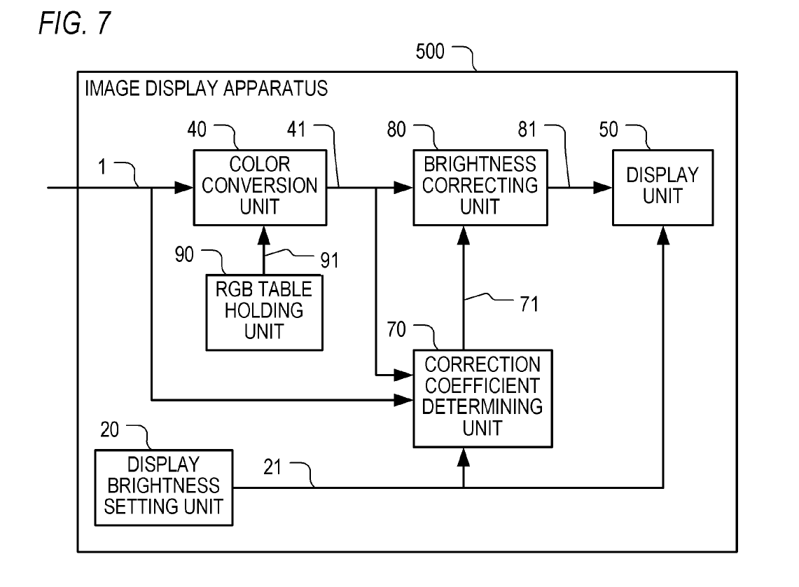

FIG. 7 is a block diagram depicting an example of a configuration of an image display apparatus 500 according to Example 3. In FIG. 7, a functional unit the same as Example 1 (FIG. 1) is denoted with a same sign as Example 1. The image display apparatus 500 has a correction coefficient determining unit 70, a brightness correcting unit 80, an RGB table holding unit 90, a display brightness setting unit 20, a color conversion unit 40, and a display unit 50.

The RGB table holding unit 90 is a storage unit for holding an RGB table 91. For the RGB table holding unit 90, a semiconductor memory, a magnetic disk, an optical disk or the like can be used. In Example 3, a ROM is used for the RGB table holding unit 90. The RGB table 91 is a 3DLUT that indicates the correspondence between RGB values (iR, iG, iB) of the input color and an RGB values (m1R, m1G, m1B) of a color after saturation of the input color is reduced (first corrected color). Therefore the corrected saturation can be acquired by using the RGB table 91. In concrete terms, the RGB values (iR, iG, iB) of the input color can be converted into the RGB values (m1R, m1G, m1B) of the first corrected color. Instead of the RGB table 91, a function that indicates the correspondence between the RGB values (iR, iG, iB) of the input color and the RGB values (m1R, m1G, m1B) of the first corrected color may be used. In this example, the first corrected color is a color within a color gamut that is narrower than the color gamut of the input color. In concrete terms, the first corrected color has RGB values of a displayable color.

The color conversion unit 40 generates the display image data 41 from the input image data 1 by performing the color conversion processing using the RGB table 91, instead of the equivalent perceptual lightness conversion table 31. The display image data 41 of Example 3 is different from the display image data 41 of Example 1. In concrete terms, the color of the display image data 41 Example 1 is the second corrected color (color after the saturation and lightness are corrected) but the color of the display image data 41 of Example 3 is the first corrected color (color after only the saturation is corrected).

The correction coefficient determining unit 70 determines a lightness correction coefficient 71 based on the input image data 1, the display image data 41, and the reference display brightness 21. The correction coefficient determining unit 70 calculates an initial effect value G0 from the RGB values (iR, iG, iB) of the input image data 1 by performing the same processing operations as the processing operations in S302 and in S305 of Example 1 (FIG. 3). Then the correction coefficient determining unit 70 calculates an HK effect value G from the RGB values (m1R, m1G, m1B) of the display image data 41 by performing the same processing operations as the processing operations in S302 and S305 in FIG. 3. Then the correction coefficient determining unit 70 calculates an HK effect ratio GR by dividing the HK effect value G by the initial effect value G0. The correction coefficient determining unit 70 outputs the calculated HK effect ratio GR as the lightness correction coefficient 71. These processing operations are performed for each pixel of the input image data 1 (display image data 41).

The brightness correcting unit 80 acquires a corrected lightness based on the display image data 41 and the lightness correction coefficient 71. Then the brightness correcting unit 80 determines a color, which has the hue of the input color (hue of the input image data 1 and the display image data 41), the corrected saturation (saturation of the display image data 41), and the acquired corrected lightness, as the output color. In concrete terms, the brightness correcting unit 80 converts the RGB values (m1R, m1G, m1B) of the display image data 41 into the RGB values (m2R, m2G, m2B) of the output color using the following Expressions 14-1 to 14-3. This processing is performed for each pixel of the display image data 41. Thereby corrected display image data 81 is generated. The brightness correcting unit 80 outputs the generated corrected display image data 81 to the display unit 50.

m2R=m1R×GR (Expression 14-1)

m2G=m1G×GR (Expression 14-2)

m2B=m1B×GR (Expression 14-3)

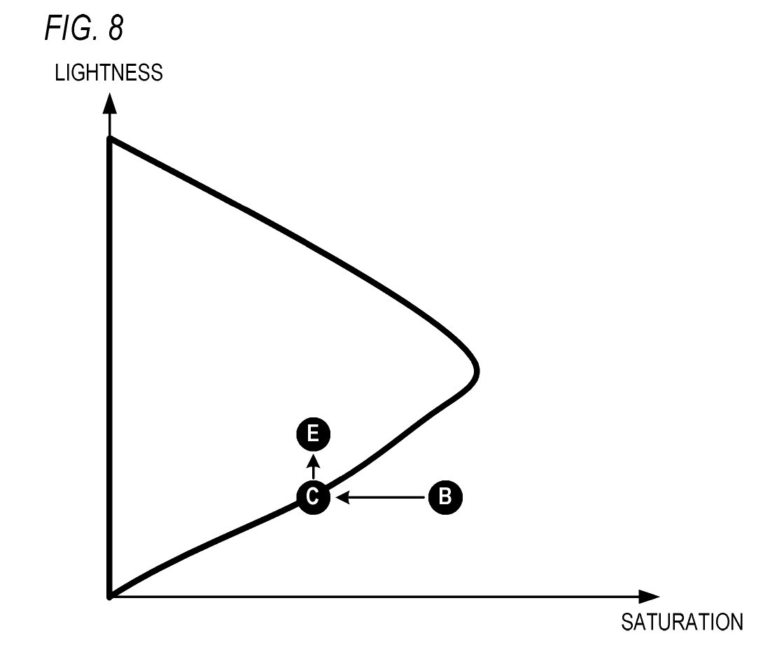

Now a concrete example of the operation of the image display apparatus 500 will be described. FIG. 8 is a diagram describing the concrete example of the operation of the image display apparatus 500. FIG. 8 shows a hue plane in the L*u*v* color space. The ordinate in FIG. 8 indicates the lightness, and the abscissa in FIG. 8 indicates the saturation. The region enclosed by the bold line is a color gamut of displayable colors. A pixel value can be plotted on any hue plane out of a plurality of hue planes. A case of plotting an input pixel value on point B in FIG. 8 will be described herein below.

First the color conversion unit 40 reduces the saturation of the input pixel value while maintaining the lightness of the input pixel value. Thereby the input pixel value is converted into a pixel value of a displayable color. In concrete terms, the input pixel value on point B is converted into a pixel value on point C. The pixel value on point C is output from the color conversion unit 40 as a pixel value of the display image data 41.

Then the correction coefficient determining unit 70 calculates the ratio of the perceptual lightness on point C with respect to the perceptual lightness of point

B as the lightness correction coefficient 71.

Then the brightness correcting unit 80 increases the lightness on point C using the lightness correction coefficient 71. In concrete terms, the pixel value on point C is converted into the pixel value on point D. The pixel value on point D is output from the brightness correcting unit 80 as the pixel value of the corrected display image data 81.

As described above, according to Example 3, not only is the saturation of the input color reduced, but also the lightness of the input color is increased. Thereby the color can be converted while maintaining the perceptual lightness at high precision. Moreover, according to Example 3, the output color can be determined by a simple method of “increasing the lightness of the input color after reducing the saturation of the input color so that the input color is converted into a displayable color”. Thereby a repeat of the processing operations in S304 to S309 in FIG. 3 can be omitted, and the output can be determined with less processing load than Example 1.

### EXAMPLE 4

Example 4 of the present invention will now be described. In Example 1, a case of using the reference display brightness, which is set by the display brightness setting unit, as the upper limit perceptual lightness (the upper limit value of the assumed perceptual lightness), was described. However, to display an image having a wider brightness dynamic range, brightness information, which is information on the brightness of each pixel, may be used. In Example 4, a case of determining the upper limit perceptual lightness based on the reference display brightness and the brightness information, will be described. In the following description, configurations and processing operations which are different from Example 1 will be described in detail, and description on the configurations and processing operations the same as Example 1 will be omitted.

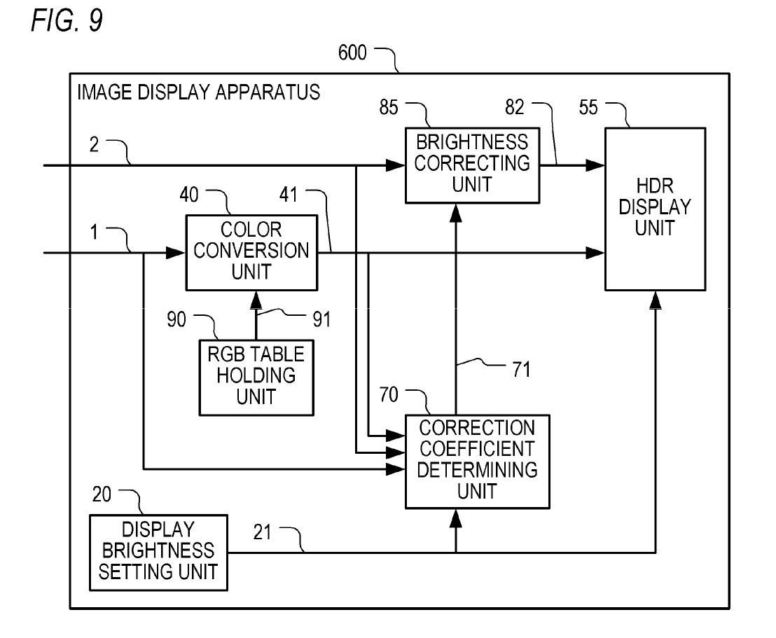

FIG. 9 is a block diagram depicting an example of a configuration of an image display apparatus 600 according to Example 4. In FIG. 9, a functional unit the same as Example 3 (FIG. 7) is denoted with a same sign as Example 3. The image display apparatus 500 has a high dynamic range (HDR) display unit 55, a correction coefficient determining unit 70, a brightness correcting unit 85, an RGB table holding unit 90, a display brightness setting unit 20, and a color conversion unit 40.

The input brightness information 2 is brightness information that is input to the image display apparatus 500 via an input terminal (not illustrated). The input brightness information 2 is information on the brightness of each pixel of the input image data 1. This means that the input brightness information 2 can also be referred to as “information on the lightness of each pixel of the input image data 1”. A pixel of which value of the input brightness information 2 is 10 is a pixel to be displayed at a brightness that is 10 times the brightness corresponding to the input pixel value (pixel value of the input image data 1). A terminal to which the input image data 1 is input may be the same as the terminal to which the input brightness information 2 is input, or may be different from the terminal to which the input brightness information 2 is input. The input brightness information 2 may be linked to the input image data 1 as metadata.

The correction coefficient determining unit 70 determines the lightness correction coefficient 71 based on the input image data 1, the input brightness information 2, the display image data 41, and the reference display brightness 21. The lightness correction coefficient 71 is determined by the same method as the method of Example 3. In Example 4, however, an HK effect factor K is calculated using the following Expression 15. In Expression 15, Yg denotes a value of the input brightness information 2. In other words, in Example 4, La×Yg is used as an upper limit perceptual lightness.

K=0.2717×((6.649+6.362×(La×Yg)^{0.4995})/(6.649+(La×Yg)^{0.4995})) (Expression 15)

The brightness correcting unit 85 acquires the corrected lightness based on the input brightness information 2 and the lightness correction coefficient 71. Then a color having the hue of the input color (hue of the input image data 1 and the display image data 41), the corrected saturation (saturation of the display image data 41), and the acquired corrected lightness, is determined as the output color by the color conversion unit 40 and the brightness correcting unit 85. In concrete terms, the brightness correcting unit 85 calculates the value of the corrected brightness information 82 by multiplying the value of the input brightness information 2 by the lightness correction coefficient 71. This processing is performed for each pixel of the display image data 41. Thereby the information on the corrected lightness of each pixel is generated as the corrected brightness information 82. The above mentioned output color is expressed by the corrected brightness information 82 and the display image data 41. The brightness correcting unit 85 outputs the generated corrected brightness information 82 to the HDR display unit 55. The display image data 41 may be corrected using the lightness correction coefficient 71, similarly to Example 3.

The HDR display unit 55 displays an image on the screen based on the reference display brightness 21, the corrected brightness information 82, and the display image data 41. In Example 4, the HDR display unit 55 is a transmission type display unit that has a backlight module and a liquid crystal panel. The backlight module irradiates light onto the rear surface of the liquid crystal panel. The liquid crystal panel generates a transmittance pattern corresponding to the image data input to the HDR display unit 55. The emission brightness of each one of a plurality of regions of the backlight module can be individually controlled. The backlight module emits light at an emission brightness (emission intensity) based on the reference display brightness 21 and the corrected brightness information 82. Thereby the brightness (display brightness) in a screen region, in which the pixel value of the display image data 41 is a pixel value of a 100% white pixel and the value of the corrected brightness information 82 is 1, approximately matches with the brightness specified by the reference display brightness 21. Further, the brightness in a screen region, in which the pixel value of the display image data 41 is a pixel value of a 100% white pixel and the value of the corrected brightness information 82 is 10, approximately matches the brightness that is 10 times the brightness specified by the reference display brightness 21.

As described above, according to Example 4, the upper limit perceptual lightness is acquired considering the brightness information in a configuration where the brightness information is used. Then using this upper limit perceptual lightness, not only is the saturation of the input color reduced, but also the lightness of the input color is increased. Thereby the color can be converted while maintaining the perceptual lightness at high precision in a configuration where the brightness information is used.

### EXAMPLE 5

Example 5 of the present invention will now be described. The upper limit value of the display brightness may be restricted due to such reasons as preventing display unit breakdown. In this example, a case of determining the upper limit perceptual lightness based on the reference display brightness, which is set by the display brightness setting unit, and the restricted upper limit value (restricted upper limit value of the display brightness), will be described. In the following description, configurations and processing operations which are different from Example 1 will be described in detail, and description on the configurations and processing operations the same as Example 1 will be omitted.

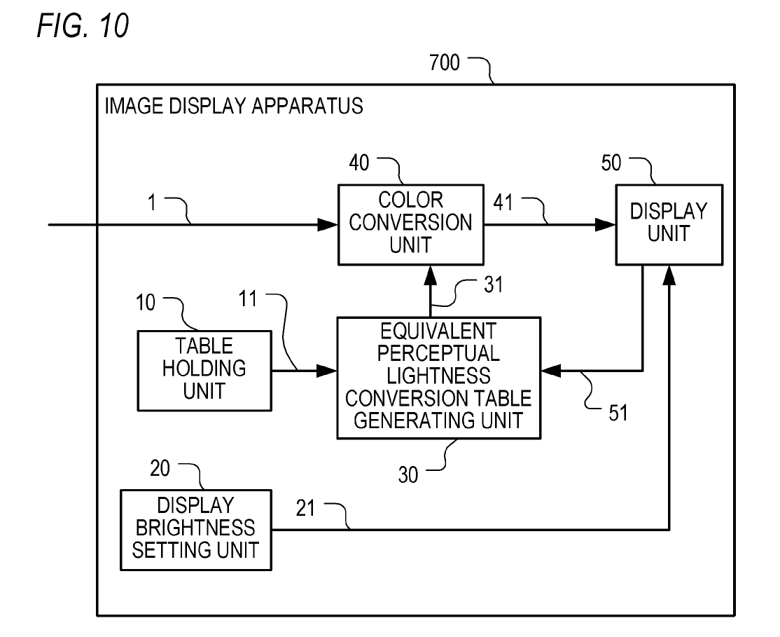

FIG. 10 is a block diagram depicting an example of a configuration of an image display apparatus 700 according to Example 5. In FIG. 10, a functional unit the same as Example 1 (FIG. 1) is denoted with a same sign as Example 1. The image display apparatus 700 has a table holding unit 10, a display brightness setting unit 20, an equivalent perceptual lightness conversion table generating unit 30, a color conversion unit 40,and a display unit 50.

The display unit 50 performs the same processing as the display unit 50 of Example 1. The display unit 50 of Example 5, however, restricts the display brightness based on a detected value of a current sensor, a detected value of a heat sensor and the like. For example, even when the value of the reference display brightness 21 is 1000 [cd/m²], the value of the reference display brightness 21 is restricted from 1000 [cd/m²] to 800 [cd/m²] if the internal temperature of the image display apparatus 700 rises to a very high temperature due to a lengthy period of continuous displaying. As a result, the display brightness is reduced. Then the display unit 50 outputs the reference display brightness currently in use as the actual display brightness 51. In the case where the display brightness is not restricted, a value the same as the reference display brightness 21 is output from the display brightness setting unit 20 as the actual display brightness 51. In the case where the display brightness is restricted, a value smaller than the reference display brightness 21 is output from the display brightness setting unit 20 as the actual display brightness 51. In other words, in the case where the display brightness is restricted, the restricted upper limit value is output as the actual display brightness 51.

The equivalent perceptual lightness conversion table generating unit 30 performs the same processing as the equivalent perceptual lightness conversion table generating unit 30 of Example 1. The equivalent perceptual lightness conversion table generating unit 30 of Example 5, however, uses the actual display brightness 51 output from the display unit 50, instead of the reference display brightness 21 output from the display brightness setting unit 20. Furthermore, the equivalent perceptual lightness conversion table generating unit 30 of Example 5 generates (updates) the equivalent perceptual lightness conversion table 31 every time the actual display brightness 51 is changed.

Similarly to the case of restricting the rise in heat, the present invention can be applied in the same manner to a case of performing display brightness control to restrict the upper limit of the power consumption. For example, the average picture level (APL) of the input image data 1 is calculated, and if the APL exceeds a predetermined threshold, the actual display brightness 51 is calculated with restricting the reference display brightness 21 according to the degree of exceeding the threshold (difference between the APL and the predetermined threshold). The other configurations and operations are the same as those of FIG. 5, described above. In this way, the image can be displayed while maintaining the perceptual lightness in the screen, even if the display screen is darkened by automatically performing the display brightness control in accordance with the brightness characteristic value of the input image data 1.

As described above, according to Example 5, the reference display brightness can be acquired considering the restricted upper limit value in a configuration where the upper limit value of the display brightness is restricted. Then using this reference display brightness, not only is the saturation of the input color reduced, but also the lightness of the input color is increased. Thereby the color can be converted while maintaining the perceptual lightness at high precision in a configuration where the upper limit value of the display brightness is restricted.

### EXAMPLE 6

Example 6 of the present invention will now be described. In this example, a case of implementing the processing described in the above mentioned examples by software will be described.

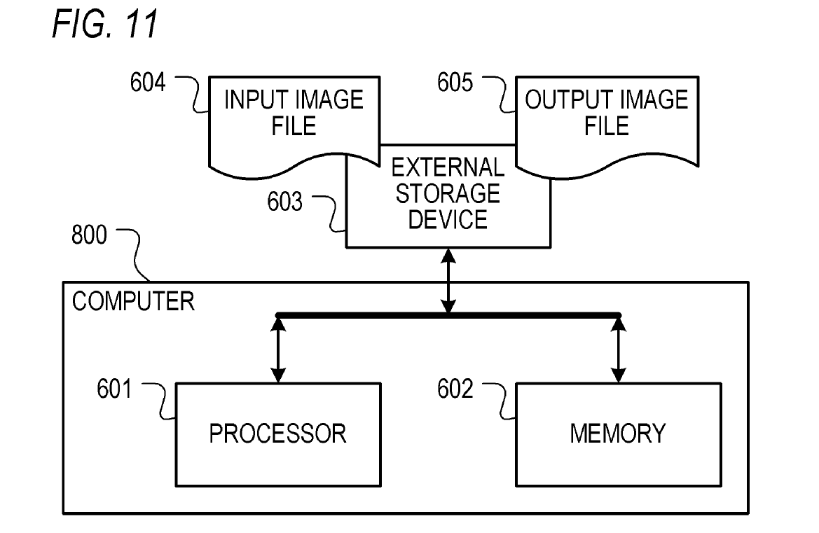

FIG. 11 is a block diagram depicting an example of a configuration of a computer 800 that executes software according to Example 6. The computer 800 has a processor 601 and a storage unit 602. An external storage device 603 is connected to the computer 800.

The storage unit 602 can store various data. For the storage unit 602, a semiconductor memory, a magnetic disk, an optical disk or the like can be used. In Example 6, a software program that implements the processing operations described in the above mentioned examples is stored in the storage unit 602. The storage unit 602 can also be used as a work memory, which temporarily stores data used for the processing operations by the processor 601.

The processor 601 performs various information processing operations, such as control of each functional unit of the computer 800, and control of each apparatus connected to the computer 800. For example, the processor 601 reads the program from the storage unit 602, and executes the read program. Thereby the processing operations described in the above mentioned examples are implemented.

The external storage device 603 can store various data. For the external storage device 603, a semiconductor memory, a magnetic disk, an optical disk or the like can be used. In Example 6, the external storage device 603 stores an input image file 604, which is input image data in file format. Further, the processor 601 records an output image file 605, which is output image data in file format, in the external storage device 603. The input image data is image data before the color conversion processing, and the output image data is image data after the color conversion processing. The external storage device 603 is detachable from the computer 800. A storage unit housed in the computer 800 may be used instead of the external storage device 603.

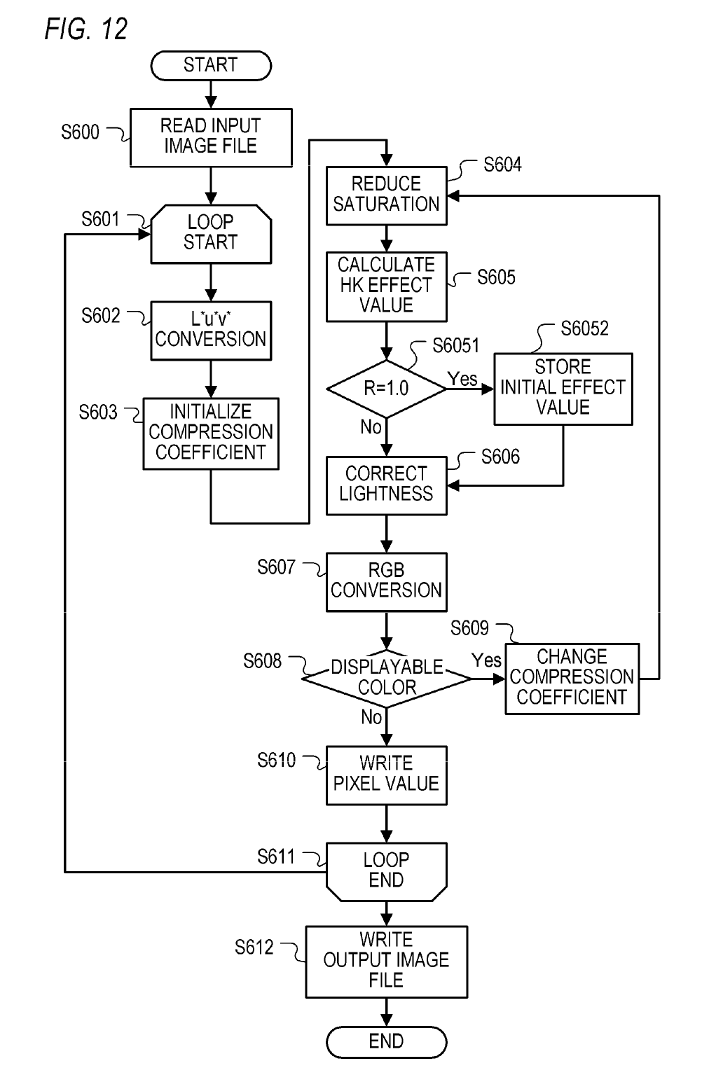

Now an example of a processing flow of the software according to Example 6 will be described. FIG. 12 is a flow chart depicting an example of the processing flow of the software according to Example 6.

First in S600, the processor 601 reads an input image file 604 from the external storage device 603, and stores the data of the read input image file 604 (input image data) to the storage unit 602.

Then in S601, the processor 601 starts loop processing. The loop processing in S601 is a repeat of the processing to select a color of a pixel of the input image data, which was acquired in S600, as an input color. By the loop processing in S601, a color of each pixel of the input image data is sequentially selected as the input color. In Example 6, pixel values of each pixel of the input image data are sequentially selected as the pixel values (iR, iG, iB) of the input color in S601.

The processing operations in S602 to S609 are the same as the processing operations in S302 to S309 of Example 1 (FIG. 3). The reference display brightness used in S602 to S609 may be a value that the user input to the computer 800, or may be a predetermined fixed value, or may be a value automatically determined by the computer 800.

In S610, the processor 601 stores the pixel values (oR, oG, oB) acquired in S607 to the storage unit 602 as a pixel values of the output image data at a same position as the pixel values (iR, iG, iB) selected in S601.

Then in S611, the processor 601 determines whether or not the processing operations in S601 to S610 were performed for all the pixel values of the input image data. If a pixel value which was not selected in S601 exists, the processing returns to S601. Then the processing operations in S601 to S611 are repeated until the processing operations in S601 to S610 are performed for all the pixel values. In a case where the processing operations in S601 to S610 are performed for all the pixel values, the processing advances to S612.

In S612, the processor 601 reads each pixel value of the output image data from the storage unit 602, generates an image file (output image file 605) based on the read pixel value, and writes the generated output image file 605 to the external storage device 603.

As described above, according to Example 6, the same processing operations as the above mentioned examples can be performed by software. Thereby the same effect as the above mentioned examples can be acquired by software.

### EXAMPLE 7

Example 7 of the present invention will now be described. In Example 1, a case of increasing the lightness of the input color while reducing the saturation of the input color was described. In Example 7, a case of reducing the saturation of the input color, after converting the lightness of the input color into the perceptual lightness considering the HK effect, will be described. In the following, configurations and processing operations which are different from Example 1 will be described in detail, and description on the configurations and processing the same as Example 1 will be omitted.

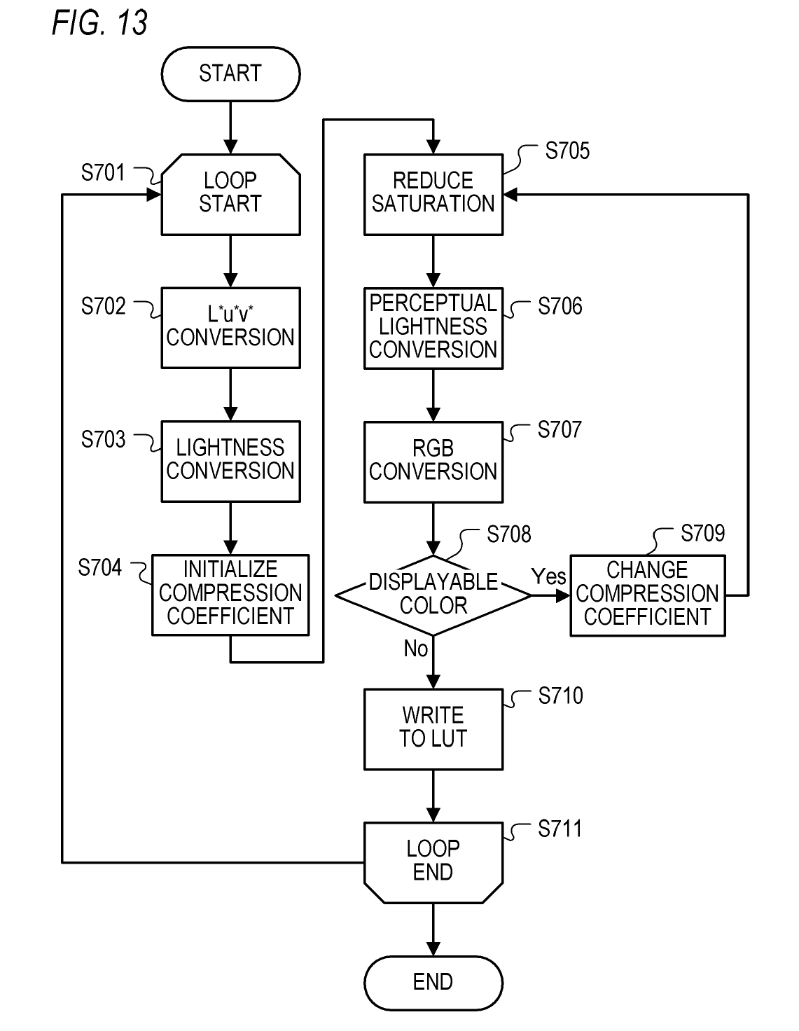

The configuration of the image display apparatus according to Example 7 is the same as Example 1. However, the operation of the equivalent perceptual lightness conversion table generating unit 30 of Example 7 is different from that of Example 1. An example of the operation of the equivalent perceptual lightness conversion table generating unit 30 according to Example 7 will be described. FIG. 13 is a flow chart depicting the example of the operation of the equivalent perceptual lightness conversion table generating unit 30 according to Example 7.

The processing in S701 is the same as the processing in S301 of Example 1 (FIG. 3), and the processing in S702 is the same as the processing in S302 of FIG. 3.

In S703 after S702, the equivalent perceptual lightness conversion table generating unit 30 calculates the HK effect value (initial effect value) G0 corresponding to the L*u*v* values (L0, U0, V0), and converts the lightness L0 into a perceptual lightness L0hk considering the HK effect. Thereby, perceptual color coordinate values (L0hk, U0, V0) are acquired. The initial effect value G0 is calculated by the same method as Example 1 (processing in S305 in FIG. 3). The perceptual lightness L0hk is calculated using the following Expression 16.

L0hk=L0×G0 (Expression 16)

Then in S704, the equivalent perceptual lightness conversion table generating unit 30 initializes the reduction coefficient R to 1.0.

Then in S705, the equivalent perceptual lightness conversion table generating unit 30 calculates the perceptual color coordinate values (L0hk, U, V) of the color after the saturation of the input color is reduced (first corrected color) according to the following Expressions 17-1 and 17-2.

U=U0×R (Expression 17-1)

V=V0×R (Expression 17-2)

Then in S706, the equivalent perceptual lightness conversion table generating unit 30 calculates the HK effect value G corresponding to the perceptual color coordinate values (L0hk U, V), and converts the perceptual lightness L0hk into a corrected lightness L. Thereby the L*u*v* values (L, U, V) of the output color are acquired. The HK effect value G is calculated by the same method as Example 1 (processing in S305 in FIG. 3) using the perceptual lightness L0hk as lightness. The corrected lightness L is calculated using the following Expression 18.

L=L0hk/G (Expression 18)

The processing operations in S707 to S711 are the same as the processing in S307 to S311 in FIG. 3.

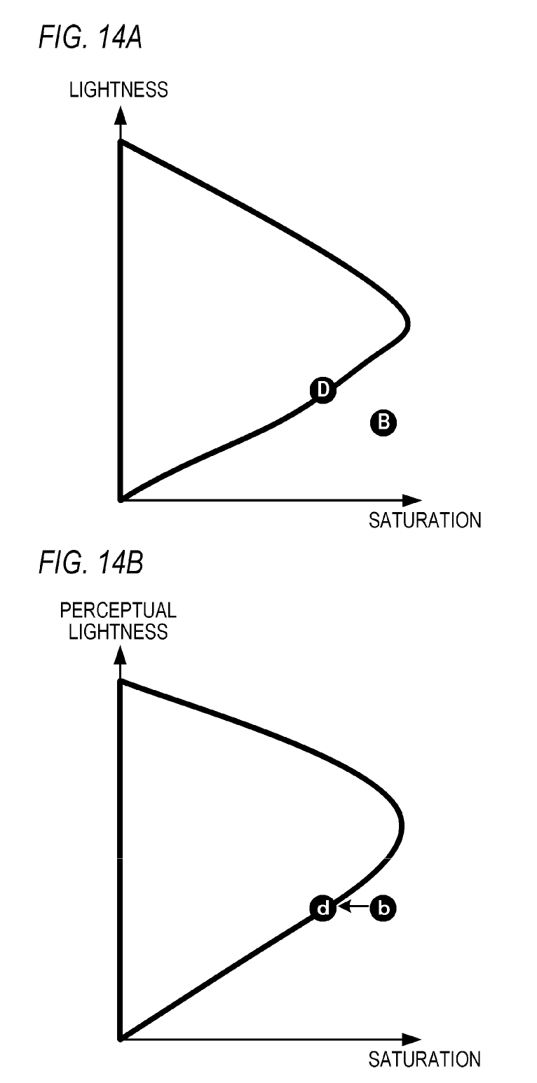

Now a concrete example of the operation of the image display apparatus according to Example 7 will be described. FIGS. 14A and 14B are diagrams for describing the concrete example of the operation of the image display apparatus according to Example 7. FIG. 14A shows a hue plane in the L*u*v* color space, and FIG. 14B shows a hue plane in the perceptual color space. The ordinate of FIG. 14A indicates the lightness, and the abscissa of FIG. 14A indicates the saturation. The ordinate of FIG. 14B indicates the perceptual lightness, and the abscissa of FIG. 14B indicates the saturation. The region enclosed by the bold line is a color gamut of displayable colors. A pixel value can be plotted on any hue plane out of a plurality of hue planes. In the following, a case of plotting the L*u*v* values (L0, U0, V0) of the input color on point B in FIG. 14A will be described.

First the lightness L0 of the input color is converted into the perceptual lightness L0hk, and the L*u*v* values (L0, U0, V0) are converted into the perceptual color coordinate values (L0hk, U0, V0). In concrete terms, the coordinate values of point B are converted into the coordinate value of point b. In other words, point B in the L*u*v* color space is mapped in the perceptual color space.

Then the saturation of the perceptual color coordinate values (L0hk, U0, V0) is reduced, and the perceptual color coordinate values (L0hk, U0, V0) are converted into the perceptual color coordinate values (L0hk, U, V). In concrete terms, the coordinate values of point b are converted into the coordinate values of point d.

Then the perceptual lightness L0hk is converted into the corrected lightness L, and the perceptual color coordinate values (L0hk, U, V) are converted into the L*u*v* values (L, U, V). In concrete terms, the coordinate values of point d are converted into coordinate values of point D. In other words, point d in the perceptual color space is mapped in the L*u*v* color space.

As described above, in Example 7 as well, not only is the saturation of the input color reduced, but also the lightness of the input color is increased. Thereby the color can be converted while maintaining the perceptual lightness at high precision.

### EXAMPLE 8

There is an image display apparatus (HDR display apparatus), in which the dynamic range of the brightness that can be handled as image data is considerably expanded compared with conventional apparatuses, that can accurately reproduce (represent) a specular reflector or a spontaneous light-emitting object. The present invention can also be applied to an HDR display apparatus.

In the case of displaying an image conforming to HDR (the above mentioned expanded dynamic range), the HDR display apparatus can display at a very high brightness compared with conventional display apparatuses. However, such a high brightness is restricted in usage, primarily for a specular reflector and a spontaneous light-emitting object. An observer as well is not accustomed to such high brightness. Therefore in a case where the present invention is applied to an HDR display apparatus, a more appropriate value should be used for a brightness constant La to calculate the HK effect factor K.

Here a case where the electro-optical transfer function (EOTF) of the input image data 1 is a ratio with respect to the reference white will be considered. In concrete terms, a case where the EOTF of the input image data 1 is a standard signal, that is defined in a 0% to 1000% range, will be considered. In this case, it is preferable that the brightness, at which 100% reference white is displayed, is a brightness constant La. For example, if the image display apparatus is set such that the maximum value of the EOTF of the input image data 1 is 1000% and a pixel with a 1000% EOTF is displayed at 2000 cd/m², then 200 cd/m² is set as a value of the brightness constant La. In the same manner, if it is set such that a pixel with a 1000% EOTF is displayed at 500 cd/m², then 50 cd/m² is set as a value of the brightness constant La.

In a case where a pixel having high brightness is displayed with restricting the brightness to a predetermined brightness as well, it is preferable to determine the brightness constant La based on the same concept. For example, it is assumed that pixels with a 0% to 400% EOTF, out of a 0% to 1000% range, are displayed at a brightness of 0 cd/m² to 400 cd/m², and pixels with a 400% or higher EOTF are displayed at a brightness restricted to 400 cd/m². In this case, a pixel with a 100% EOTF is displayed at 100 cd/m², hence the brightness constant La is set to 100 cd/m².

In the case where the EOTF of the input image data 1 is a standard signal defined by the absolute value of the brightness as well, the brightness constant La can be determined based on the same concept. In this case, it is necessary to additionally determine the brightness [cd/m²] of the 100% reference white. For example, if the brightness of 100% white has been defined as metadata linked to the input image data 1, this value (defined brightness) is preferably used as the brightness constant La. If the metadata is not available, an arbitrary brightness set by the user, or a brightness which is appropriate as a default value unique to the apparatus, may be used as the brightness constant La. In this case, it is preferable that the brightness in a range of 100 cd/m² to 500 cd/m² is used as the brightness constant La. The reference display brightness may be estimated by analyzing the input image data 1. For example, the APL of the image may be calculated, and the maximum APL (maximum value of APL) of the content (e.g. moving image constituted by a plurality of frames), including a plurality of images, may be estimated as the reference display brightness. And the estimated reference display brightness may be used as the brightness constant La.

The present invention has been described using preferred embodiments, but the present invention is not limited to these specific embodiments, and various forms within a scope of not departing from the spirit of the present invention are included in the present invention. The above mentioned examples may be partially combined.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to readout and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-203978, filed on Oct. 15, 2015, and Japanese Patent Application No. 2016-153474, filed on Aug. 4, 2016, which are hereby incorporated by reference herein in their entirety.

What is claimed is:

1. An image display apparatus comprising:
a setting unit configured to perform setting related to display brightness of the image display apparatus; and
a correcting unit configured to reduce saturation of an input color and increase lightness of an input color, wherein
the correcting unit determines an amount of increasing the lightness of the input color based on the display brightness, which has been set by the setting unit.

2. The image display apparatus according to claim 1, wherein
the correcting unit increases the amount of increasing the lightness of the input color as the display brightness, which has been set by the setting unit, is higher.

3. The image display apparatus according to claim 1, wherein the correcting unit comprises:
a first correcting unit configured to reduce the saturation of an input color so as to acquire corrected saturation, which is the saturation of the input color after the reduction; and
a second correcting unit configured to increase the lightness of an input color, based on the saturation of the input color before the reduction, the corrected saturation, and the display brightness, which has been set by the setting unit, so as to acquire corrected lightness, which is the lightness of the input color after the increase.

4. The image display apparatus according to claim 3, wherein
a difference between the lightness of the input color before the reduction and the corrected lightness is greater as a difference between the saturation of the input color before the reduction and the corrected saturation is greater.

5. The image display apparatus according to claim 1, wherein
the setting unit sets a reference value of the display brightness of the image display apparatus, and
the correcting unit determines the amount of increasing the lightness of the input color, based on the reference value, which has been set by the setting unit.

6. The image display apparatus according to claim 1, wherein
the setting unit sets an upper limit value of the display brightness of the image display apparatus, and
the correcting unit determines the amount of increasing the lightness of the input color, based on the upper limit value, which has been set by the setting unit.

7. The image display apparatus according to claim 1, wherein the correcting unit increases the lightness of the input color, based on the Helmholtz-Kohlrausch effect.

8. The image display apparatus according to claim 1, wherein
the correcting unit decreases the saturation of the input color and increases the lightness of the input color such that a color in a color gamut narrower than a color gamut of the input color is determined as an output color.

9. The image display apparatus according to claim 8, wherein
the correcting unit repeats increasing the lightness of the input color while gradually decreasing the saturation of the input color, until the color in the color gamut narrower than the color gamut of the input color is determined as the output color.

10. The image display apparatus according to claim 8, wherein
the correcting unit decreases the saturation of the input color such that the input color is converted into a color in the color gamut narrower than the color gamut of the input color.

11. The image display apparatus according to claim 1, wherein
the correcting unit determines the amount of increasing the lightness of the input color, also based on hue of the input color.

12. The image display apparatus according to claim 1, further comprising:
a selecting unit configured to select each color in a predetermined color gamut as an input color.

13. The image display apparatus according to claim 1, further comprising:
a selecting unit configured to select a color of each pixel of input image data as an input color; and
a converting unit configured to convert the color of each pixel of the input image data into an output color.

14. The image display apparatus according to claim 1, further comprising:
a storing unit configured to store color conversion information for converting an input color into an output color; and
a converting unit configured to convert a color of each pixel of input image data, based on the color conversion information.

15. The image display apparatus according to claim 1, wherein
the setting unit performs setting related to the display brightness of the image display apparatus according to user operation.

16. The image display apparatus according to claim 1, wherein
the setting unit performs setting related to the display brightness of the image display apparatus according to temperature of the image display apparatus.

17. The image display apparatus according to claim 1, wherein
the setting unit performs setting related to the display brightness of the image display apparatus in accordance with a brightness characteristic value of an image displayed on the image display apparatus.

18. A color conversion apparatus comprising:
an acquiring unit configured to acquire information related to display brightness set in an image display apparatus; and
a correcting unit configured to reduce saturation of an input color and increase lightness of an input color, wherein
the correcting unit determines an amount of increasing the lightness of the input color, based on the display brightness, which has been set in the image display apparatus.

19. A color conversion method comprising:
acquiring information related to display brightness set in an image display apparatus;
reducing saturation of an input color; and
increasing lightness of an input color, wherein
an amount of increasing the lightness of the input color is determined based on the display brightness, which has been set in the image display apparatus.

20. A non-transitory computer readable medium that stores a program, wherein
the program causes a computer to execute:
acquiring information related to display brightness set in an image display apparatus;
reducing saturation of an input color; and
increasing lightness of an input color, and
an amount of increasing the lightness of the input color is determined based on the display brightness, which has been set in the image display apparatus.
